(19) United States
(12) Patent Application Publication
(10) Pub. No.: US 2015/0359375 A1
(43) Pub. Date: Dec. 17, 2015

(54) Pressurized Beverage Maker

(71) Applicant: Hamilton Beach Brands, Inc., Glen Allen, VA (US)

(72) Inventor: Patrick T. Mulvaney, Richmond, VA (US)

(21) Appl. No.: 14/305,542

(22) Filed: Jun. 16, 2014

(51) Int. Cl. A47J 31/32; A47J 31/46

(52) U.S. Cl. CPC A47J 31/32; A47J 31/462

(57) ABSTRACT

A pressurized beverage making system comprises a reservoir, a heater in thermal connection with the reservoir, an air pump selectively fluidly connected to the reservoir, an outlet tube extending from an interior of the reservoir to a hot water outlet, and a vent valve. The vent valve comprises (1) a first position that defines a first flow path for air in the reservoir to escape the interior chamber of the reservoir via the vent valve and first flow path, and (2) a second position that closes the first flow path and defines a second flow path from the air pump to the interior chamber of the reservoir. The vent valve is operable to define only one of the first flow path or the second flow path at a given time. The air pump, when engaged, positively displaces the vent valve from the first position to the second position.

### FIELD OF THE DISCLOSURE

The present disclosure relates generally to a beverage maker system and, more particularly, to vent valve for a pressurized beverage maker system.

### BACKGROUND OF THE DISCLOSURE

Beverage makers include, but are not limited to, percolators, conventional automatic drip coffeemakers (ADCs) and pressurized espresso or cartridge-style beverage makers. Typical cartridge-style beverage makers can include an air pump that forces a volume of water through a cartridge containing the infusible material, such as coffee grounds, at above-ambient pressure. The pressurized cartridge-style beverage maker systems include expensive and relatively complex components, particularly in comparison to a standard ADC or other unpressurized beverage maker system.

Therefore, there is a need for a pressurized cartridge-style beverage maker system that employs simplified and more cost effective components. The device of the present disclosure accomplishes at least the above objectives and overcomes the above-described or other disadvantages of conventional pressurized beverage makers systems.

### BRIEF SUMMARY OF THE DISCLOSURE

Briefly stated, a pressurized beverage making system comprising a reservoir a vent valve is disclosed. The vent valve includes an interior chamber and a first and second position. The first position partially defines a first flow path for air in the reservoir to escape the interior chamber for the reservoir via the vent valve and the first flow path. The second position closes the first flow path and opens a second flow path from an air pump to the reservoir. The air pump displaces the vent vale from the first position to the second position when the air pump is actuated. A method for operating the same and further related embodiments of the subject apparatus and method are disclosed herein.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there is shown in the drawings an embodiment which is presently preferred. It should be understood, however, that the disclosure is not limited to the precise arrangements and instrumentalities shown. In the drawings:

FIG. 1 is a system schematic overview illustrating the various components of one embodiment of the a beverage brewing system including the subject vent valve;

FIGS. 2A and 2B are cross-sectional side views of one embodiment of the subject vent valve illustrating a first flow path where air in the reservoir vents to atmosphere (FIG. 2A) and a second flow path where air enters the reservoir via an air pump inlet and the vent valve (FIG. 2B);

FIGS. 3A and 3B illustrate another embodiment thereof; and

FIGS. 4A and 4B illustrate another embodiment thereof.

### DETAILED DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

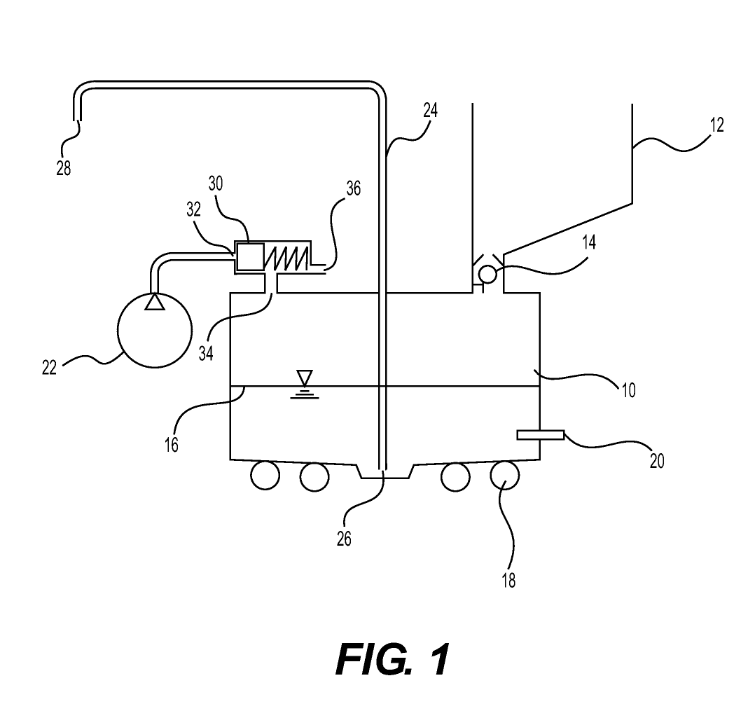

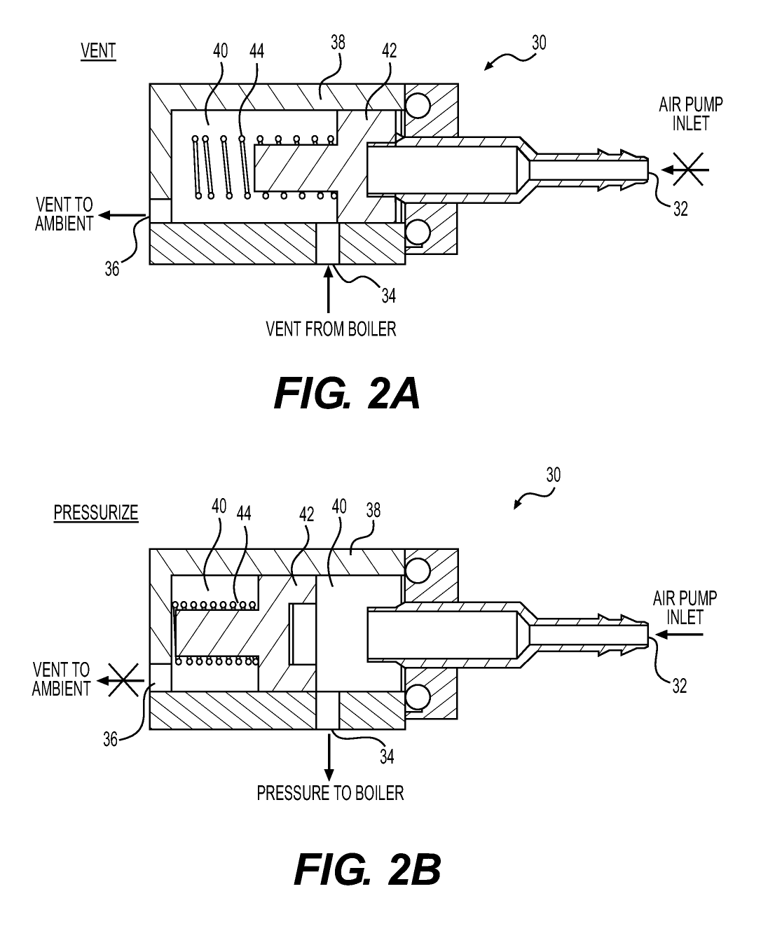

FIGS. 1-2 illustrate a beverage brewing system and a component thereof in accordance with one embodiment of the present disclosure. The brewing system is intended or designed for creating hot or cold beverages or creating hot water. The brew system is operable with infusible material, be it loose leaves or grounds, in a pre-packaged soft pod, or a hard cartridge.

Referring to FIG. 1, the beverage brewing system includes a water inlet 12 to a reservoir or boiler 10. The water inlet 12 includes a check valve 14, one-way valve, pressure seal, lid, or the like. The reservoir or boiler 10 includes two outlets. The first outlet is presented via a vent valve 30. The vent valve is positioned above the water inlet. The second outlet is an outlet tube 24. The outlet tube 24 extends from an outlet tube inlet 26 positioned adjacent the bottom of the interior of the reservoir 10 to an outlet tube outlet 28 positioned external to the reservoir 10. A heater 18 is adjacent the reservoir 10 to heat or boil the contents thereof (e.g., water 16).

Once the fluid in the boiler 10 reaches a desired temperature, as monitored by a temperature probe 20 that is in or otherwise thermally connected to the reservoir 10, an air pump 22 can be actuated. Activation of the air pump 22 displaces (due to the air pressure from the air pump 22) a seal in the vent valve 30 to close the first outlet or flow path 34/36. Prior to activation of the air pump 22, the first flow path 34/36 is open to permit air to exit the reservoir 10 out into the ambient air. The seal in the vent valve 30 is biased into this first position (which may be termed the “vent” position).

Once the seal in the vent valve 30 is displaced, the vent valve 30 defines a second flow path 32/34 that permits air from the air pump 22 into the reservoir 10. The air pressure provided by the air being pumped maintains the seal in the vent valve 30 in this second position (which may be termed the “pressurize” position). With the seal in the vent valve 30 in this second, pressurize position, the only outlet for the reservoir 10 is the outlet tube 24. As such, pressurized air from the air pump 22 forces the water 16 in the reservoir 10 to move up through the outlet tube 24 and exit through outlet 28 to a user container, passing through any optional infusible material along the way.

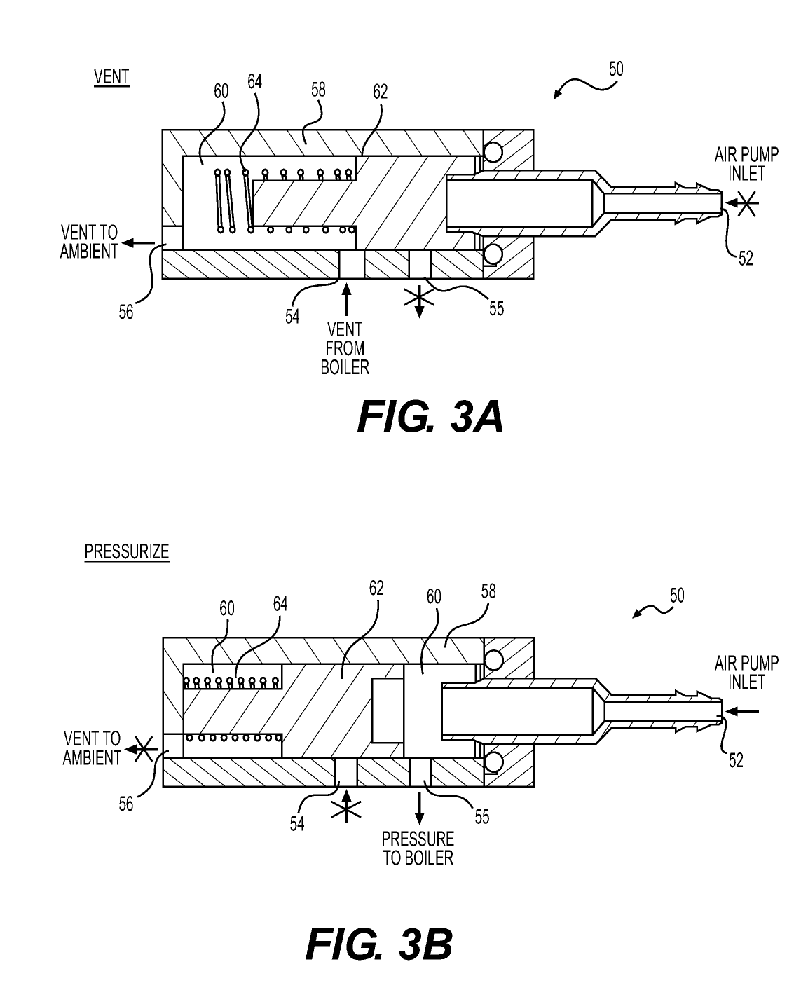

FIGS. 2A, B and 3A, B include cross sectional views of at least two embodiments of the subject vent valve. In FIGS. 2A and 2B, a vent valve 30 using a single aperture to the boiler is illustrated in the vent position (FIG. 2A) and the pressurize position (FIG. 2B). In FIGS. 3A and 3B, a vent valve 50 using two apertures to the boiler is illustrated in the vent position (FIG. 3A) and the pressurize position (FIG. 3B).

FIG. 2A illustrates the vent valve 30 in an open or vent position where air can vent from the boiler 10 to ambient as the boiler 10 is filled with water. FIG. 2B illustrates the vent valve 30 in a closed or pressurize position where air cannot vent from the boiler, such that the boiler 10 may be pressurized as air is pumped into the boiler 10 from the air pump 22. Vent valve 30 comprises an exterior wall 38 defining a chamber 40 therein. Exterior wall 38 typically has a generally cylindrical shape. A piston 42 is housed within the chamber 40 and is linearly movable between the open or vent position of FIG. 2A and the closed or pressurize position of FIG. 2B. A spring or other biasing member 44 biases the piston 42 into the open or vent position.

Three apertures are defined in the exterior wall 38. These apertures extend through the exterior wall 38 to provide access to the chamber 40. Aperture 32 provides a fluid (air) connection between the air pump 22 and the chamber 40. Aperture 34 provides a fluid (air) connection between the boiler 10 and the chamber 40. Aperture 36 provides a fluid (air) connection between the chamber 40 and ambient.

Two different airflow paths are defined through the vent valve 30 depending on the position of the piston 42. The first airflow path is defined through the vent valve 30 when the piston 42 is in the open or vent position (FIG. 2A). When the piston 42 is in the open or vent position, air vents from the boiler 10 as the boiler fills with water through aperture 34 into the chamber 40 and then exits the vent valve 30 through aperture 36 to ambient. Thus, the first airflow path is into the vent valve 30 through aperture 34, through the chamber 40, and out of the vent valve 30 through aperture 36.

When the air pump 22 is activated, air is pumped through aperture 32 into the chamber 40. This air pressure causes the piston 42 to move from the vent position to the pressurize position. When the piston 42 is in the closed or pressurize position, air flows from the air pump 22 through aperture 32 into the chamber 40 and then exits the vent valve 30 through aperture 34 into the boiler 10. Thus, the second airflow path is into the vent valve 30 through aperture 32, through the chamber 40, and out of the vent valve 30 through aperture 34.

The piston 42 stays in the pressurize position as long as the air pump 22 remains activated. When the air pump 22 is deactivated, the spring 44 biases the piston 42 back into the vent position, thereby closing off the second airflow path and re-opening the first airflow path.

The size of the piston 42 and the position of the aperture 34 are selected such that the first airflow path is open and the second airflow path is closed when the piston 42 is in the vent or open position and such that the second airflow path is open and the first airflow path is closed when the piston 42 is in the closed or pressurize position.

In use, the vent valve 30 will initially be in the first position so that, as water from the water inlet 12 fills the reservoir 10, air in the reservoir 10 can escape through the vent valve 30 to ambient. After a predetermined amount of fluid (such as water 16) has been pumped into the reservoir 10 and after the water 16 has been heated to a predetermined temperature by the heater 18, the air pump 22 is engaged to pump air through the vent valve 30 into the reservoir 10 to pressurize the interior of the reservoir 10. The pumped air from the engaged air pump 22 positively displaces the vent valve piston 42 from the first position to the second position, such that air cannot escape via the vent valve 30 and such that the air from the air pump 22 can reach the reservoir 10. The fresh water inlet may also comprise a one-way or check valve 14 to prevent air from escaping out the water inlet 12. The elevated air pressure forces fluid through the outlet tube 24. The heated fluid exits the system via the water outlet 28. The pumped water can interact with an infusible material (not illustrated) to create a flavored beverage. The infusible material may be loose, such as coffee grounds, in a pre-packaged soft pod, in a hard cartridge, or the like.

Referring now to FIGS. 3A and 3b, an alternative embodiment of a vent valve for use with a beverage making system such as the system of FIG. 1 is illustrated. Vent valve 50 uses two apertures to the boiler. FIG. 3A illustrates the vent valve 50 in an open or vent position where air can vent from the boiler 10 to ambient as the boiler 10 is filled with water. FIG. 3B illustrates the vent valve 50 in a closed or pressurize position where air cannot vent from the boiler, such that the boiler 10 may be pressurized as air is pumped into the boiler 10 from the air pump 22. Vent valve 50 comprises an exterior wall 58 defining a chamber 60 therein. Exterior wall 58 typically has a generally cylindrical shape. A piston 62 is housed within the chamber 60 and is linearly movable between the open or vent position of FIG. 3A and the closed or pressurize position of FIG. 3B. A spring 64 biases the piston 62 into the open or vent position.

Four apertures are defined in the exterior wall 58 of the vent valve 50. These apertures extend through the exterior wall 58 to provide access to the chamber 60. Aperture 52 provides a fluid (air) connection between the air pump 22 and the chamber 60. Aperture 56 provides a fluid (air) connection between the chamber 60 and ambient. Aperture 54 provides a fluid (air) connection between the boiler 10 and the chamber 60 along a first airflow path (described further below). Aperture 55 provides a fluid (air) connection between the boiler 10 and the chamber 60 along a second airflow path (described further below).

Two different airflow paths are defined through the vent valve 50 depending on the position of the piston 62. The first airflow path is defined through the vent valve 50 when the piston 62 is in the open or vent position (FIG. 3A). When the piston 62 is in the open or vent position, air vents from the boiler 10 as the boiler fills with water through aperture 54 into the chamber 60 and then exits the vent valve 50 through aperture 56 to ambient. Thus, the first airflow path is into the vent valve 50 through aperture 54, through the chamber 60, and out of the vent valve 50 through aperture 56.

When the air pump 22 is activated, air is pumped through aperture 52 into the chamber 60. This air pressure causes the piston 62 to move from the vent position to the pressurize position. When the piston 62 is in the closed or pressurize position, air flows from the air pump 22 through aperture 52 into the chamber 60 and then exits the vent valve 50 through aperture 55 into the boiler 10. Thus, the second airflow path is into the vent valve 50 through aperture 52, through the chamber 60, and out of the vent valve 50 through aperture 55.

The piston 62 stays in the pressurize position as long as the air pump 22 remains activated. When the air pump 22 is deactivated, the spring 64 biases the piston 62 back into the vent position, thereby closing off the second airflow path and re-opening the first airflow path.

The size of the piston 62 and the position of aperture 54 and aperture 55 are selected such that the first airflow path is open and the second airflow path is closed when the piston 62 is in the vent or open position and such that the second airflow path is open and the first airflow path is closed when the piston 62 is in the closed or pressurize position.

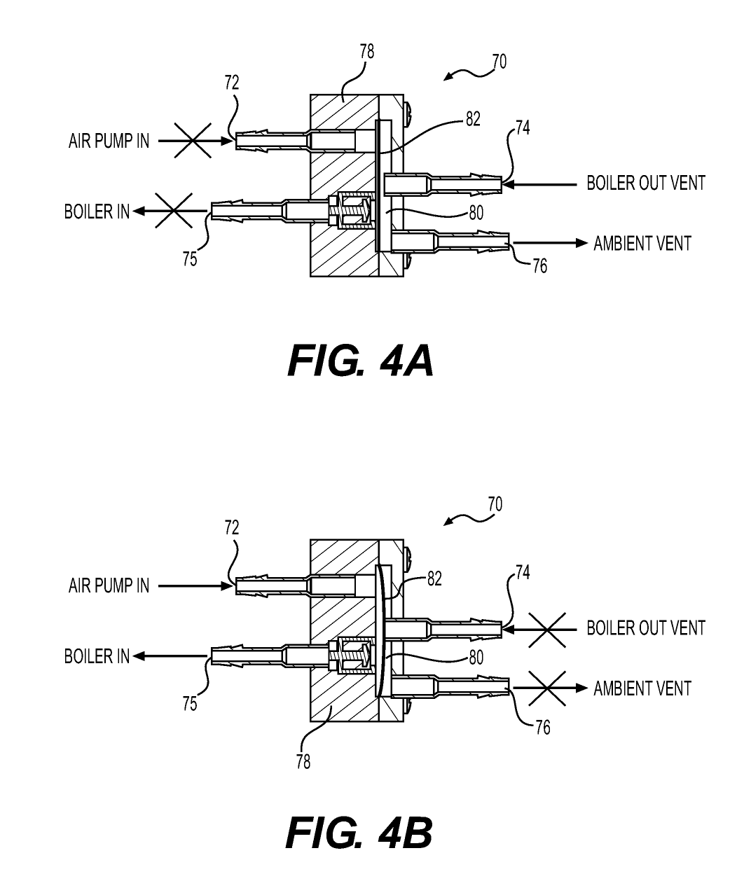

FIG. 4 represents an alternative embodiment of a vent valve for use with a beverage making system such as the system of FIG. 1. The vent valve 70 of FIG. 4 does not include a linearly displaced piston as the vent valves of FIGS. 2 and 3. Instead, the vent valve 70 includes a diaphragm 82 that controls which of two different airflow paths are open through the vent valve 70. The vent valve 70 further includes a main chamber 80 with two apertures on each of two opposing sides of the chamber. A first side (the right side as shown in FIGS. 4A and 4B) includes a reservoir/boiler vent out aperture 74 that is in fluid (air) connection with the reservoir/boiler 10 to allow air to vent in from the reservoir/boiler 10, and an ambient vent out aperture 76 in fluid (air) connection with the ambient air to allow air to vent out to ambient. The diaphragm's 82 static position is the “open” or “vent” position (FIG. 4A) whereby there is a first airflow path from the reservoir/boiler 10 through aperture 74 into the first side of chamber 80 and then out aperture 76 to the ambient. As fluid is introduced to the reservoir/boiler 10, the fluid displaces air within the reservoir/boiler 10. The air flows through into the vent valve 70 through aperture 74. The diaphragm 82 separates the chamber in a manner that allows the air to pass through the chamber 80 and out aperture 76 to ambient.

A second side (the left side as shown in FIGS. 4A and 4B) of the chamber 80 includes an air pump inlet aperture 72 and a reservoir air in aperture 75. As the air pump 22 is actuated, air pressure is applied to the chamber 80 and diaphragm 82 via the air pump inlet aperture 72. The air pressure from the air pump 22 causes the diaphragm 82 to deform in a manner that seals and/or closes the chamber's aperture 74 from the reservoir/boiler 10, thereby closing off the first airflow path. The diaphragm's position in FIG. 4B is the “closed” or “pressurize” position. The diaphragm 82 divides the chamber, providing a second airflow path when the diaphragm 82 is flexed/deformed and therefore in the closed or pressurize position such that the air from the air pump 22 leaves the chamber 80 via the reservoir air in aperture 75, thereby pressurizing the reservoir/boiler 10 to displace fluid in the reservoir/boiler 10. To maintain the pressure in the reservoir/boiler 10, the force on the diaphragm 82 from the air pump inlet aperture 72 to the chamber 80 exceeds the pressure from the reservoir/boiler vent out aperture 74. An optional check valve 84 can be located in or along the reservoir vent out passage (i.e., in or adjacent aperture 75) to help create a biasing pressure and maintain a deformed diaphragm.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

What is claimed is:

1. A pressurized beverage making system, the system comprising:
a reservoir, the reservoir including an interior chamber and a fresh water inlet;
a heater in thermal connection with the reservoir;
an outlet tube, the outlet tube extending from an interior of the reservoir to a hot water outlet;
a vent valve, the vent valve including an interior chamber, the vent valve comprising a first position and a second position, the first position defining a first flow path for air in the reservoir to escape the interior chamber of the reservoir via the vent valve and first flow path, the second position closing the first flow path and defining a second flow path from the air pump to the interior chamber of the reservoir, the vent valve operable to define only one of the first flow path or the second flow path at a given time; and
an air pump, the air pump selectively fluidly connected to the reservoir via the vent valve;
wherein the air pump positively displaces the vent valve from the first position to the second position when the air pump is engaged.

2. The pressurized beverage making system of claim 1, wherein the vent valve is biased from the second position to the first position such that the vent valve defines the first flow path when the air pump is not engaged.

3. The pressurized beverage making system of claim 1, wherein the vent valve further comprises:
an ambient aperture allowing air flow between the interior chamber of the vent valve and ambient;
only one reservoir aperture allowing air flow between the interior chamber of the vent valve and the interior chamber of the reservoir; and
an air pump aperture allowing air flow between the interior chamber of the vent valve and the air pump;
wherein the first flow path allows air to flow from the reservoir into the vent valve through the reservoir aperture and out of the vent valve to ambient through the ambient aperture; and wherein the second flow path allows air to flow from the air pump into the vent valve through the air pump aperture and from the vent valve into the reservoir through the reservoir aperture.

4. The pressurized beverage making system of claim 1, wherein the vent valve further comprises:
an ambient aperture allowing air flow between the interior chamber of the vent valve and ambient;
first and second reservoir apertures allowing air flow between the interior chamber of the vent valve and the interior chamber of the reservoir; and
an air pump aperture allowing air flow between the interior chamber of the vent valve and the air pump;
wherein the first flow path allows air to flow from the reservoir into the vent valve through the first reservoir aperture and out of the vent valve to ambient through the ambient aperture; and wherein the second flow path allows air to flow from the air pump into the vent valve through the air pump aperture and from the vent valve into the reservoir through the second reservoir aperture.

5. The pressurized beverage making system of claim 1, wherein the vent valve further comprises a piston within the interior chamber of the vent valve, the piston linearly movable between the first position and the second position and biased from the second position to the first position;
wherein the air pump positively displaces the piston from the first position to the second position when the air pump is engaged.

6. The pressurized beverage making system of claim 1, wherein the vent valve further comprises:
a diaphragm within the interior chamber of the vent valve, the diaphragm being unflexed when the air pump is not engaged and flexed when the air pump is engaged;
wherein the first flow path is open and the second flow path is closed when the diaphragm is unflexed; and wherein the first flow path is closed and the second flow path is open when the diaphragm is flexed.

7. The pressurized beverage making system of claim 6, wherein the vent valve further comprises:
an ambient aperture allowing air flow between the interior chamber of the vent valve and ambient;
a first reservoir aperture allowing air flow between the interior chamber of the vent valve and the interior chamber of the reservoir;
a second reservoir aperture allowing air flow between the interior chamber of the vent valve and the interior chamber of the reservoir; and
an air pump aperture allowing air flow between the interior chamber of the vent valve and the air pump;
wherein the ambient aperture and the first reservoir aperture are open to the interior chamber of the vent valve on a first side of the diaphragm;
wherein the second reservoir aperture and the air pump aperture are open to the interior chamber of the vent valve on a second side of the diaphragm;
wherein the first flow path allows air to flow from the reservoir into the vent valve through the first reservoir aperture and out of the vent valve to ambient through the ambient aperture;
wherein the second flow path allows air to flow from the air pump into the vent valve through the air pump aperture and from the vent valve into the reservoir through the second reservoir aperture;
wherein the diaphragm blocks the air pump aperture and/or the second reservoir aperture when the diaphragm is unflexed; and
wherein the diaphragm blocks the ambient aperture and/or the first reservoir aperture when the diaphragm is flexed.

8. A method of making a beverage, the method comprising:
pumping water into an interior chamber of a reservoir via a fresh water inlet;
allowing air to exit the reservoir via a vent valve in a first position, the vent valve including an interior chamber, the vent valve comprising the first position and a second position, the first position defining a first flow path for air in the reservoir to escape the interior chamber of the reservoir via the vent valve and first flow path, the second position closing the first flow path and defining a second flow path from the air pump to the interior chamber of the reservoir, the vent valve operable to define only one of the first flow path or the second flow path at a given time;
heating the water via a heater in thermal connection with the reservoir;
after a predetermined amount of water has been pumped into the reservoir and after the water has been heated to a predetermined temperature, engaging an air pump that is selectively fluidly connected to the reservoir via the vent valve to pump air into the reservoir to force at least some of the water out of the reservoir via an outlet tube extending from an interior of the reservoir to a hot water outlet, the pumped air from the engaged air pump positively displacing the vent valve from the first position to the second position.

9. The method of claim 8, wherein the vent valve is biased from the second position to the first position such that the vent valve defines the first flow path when the air pump is not engaged.

10. The method of claim 8, wherein the vent valve further comprises:
an ambient aperture allowing air flow between the interior chamber of the vent valve and ambient;
only one reservoir aperture allowing air flow between the interior chamber of the vent valve and the interior chamber of the reservoir; and
an air pump aperture allowing air flow between the interior chamber of the vent valve and the air pump;
wherein the first flow path allows air to flow from the reservoir into the vent valve through the reservoir aperture and out of the vent valve to ambient through the ambient aperture; and
wherein the second flow path allows air to flow from the air pump into the vent valve through the air pump aperture and from the vent valve into the reservoir through the reservoir aperture.

11. The method of claim 8, wherein the vent valve further comprises:
an ambient aperture allowing air flow between the interior chamber of the vent valve and ambient;
first and second reservoir apertures allowing air flow between the interior chamber of the vent valve and the interior chamber of the reservoir; and
an air pump aperture allowing air flow between the interior chamber of the vent valve and the air pump;
wherein the first flow path allows air to flow from the reservoir into the vent valve through the first reservoir aperture and out of the vent valve to ambient through the ambient aperture; and
wherein the second flow path allows air to flow from the air pump into the vent valve through the air pump aperture and from the vent valve into the reservoir through the second reservoir aperture.

12. The method of claim 8, wherein the vent valve further comprises a piston within the interior chamber of the vent valve, the piston linearly movable between the first position and the second position and biased from the second position to the first position;
wherein the air pump positively displaces the piston from the first position to the second position when the air pump is engaged.

13. The method of claim 8, wherein the vent valve further comprises:
a diaphragm within the interior chamber of the vent valve, the diaphragm being unflexed when the air pump is not engaged and flexed when the air pump is engaged;
wherein the first flow path is open and the second flow path is closed when the diaphragm is unflexed; and wherein the first flow path is closed and the second flow path is open when the diaphragm is flexed.

14. The method of claim 13, wherein the vent valve further comprises:
an ambient aperture allowing air flow between the interior chamber of the vent valve and ambient;
a first reservoir aperture allowing air flow between the interior chamber of the vent valve and the interior chamber of the reservoir;
a second reservoir aperture allowing air flow between the interior chamber of the vent valve and the interior chamber of the reservoir; and
an air pump aperture allowing air flow between the interior chamber of the vent valve and the air pump;
wherein the ambient aperture and the first reservoir aperture are open to the interior chamber of the vent valve on a first side of the diaphragm;
wherein the second reservoir aperture and the air pump aperture are open to the interior chamber of the vent valve on a second side of the diaphragm;
wherein the first flow path allows air to flow from the reservoir into the vent valve through the first reservoir aperture and out of the vent valve to ambient through the ambient aperture;
wherein the second flow path allows air to flow from the air pump into the vent valve through the air pump aperture and from the vent valve into the reservoir through the second reservoir aperture;
wherein the diaphragm blocks the air pump aperture and/or the second reservoir aperture when the diaphragm is unflexed; and
wherein the diaphragm blocks the ambient aperture and/or the first reservoir aperture when the diaphragm is flexed.
